(19) United States
(12) Patent Application Publication
(10) Pub. No.: US 2011/0110369 A1
(43) Pub. Date: May 12, 2011

(54) RELAY DEVICE

(75) Inventor: Osamu SHIRAKI, Kawasaki (JP)

(73) Assignee: FUJITSU LIMITED, Kawasaki-shi (JP)

(21) Appl. No.: 12/940,731

(22) Filed: Nov. 5, 2010

(30) Foreign Application Priority Data
Nov. 11, 2009 (JP) 2009-258246

(51) Int. Cl. H04L 12/56

(52) U.S. Cl. 370/389

(57) ABSTRACT

A disclosed relay device includes a port group determining unit for associating group identification information indicating combinations of ports set up in a receive port with the frame, a relay unit learning a correspondence between the receive port and a node which is a transmission source and determining a transmit port from which the frame is transmitted based on the learnt correspondence, a port group membership memory unit storing a membership information piece indicative of the plurality of combinations of ports, and a filtering unit limiting the transmit port, wherein the port group determining unit associates the group identification information to the received frame when group identification information has been given, and the filtering unit does not limit the transmit port when the learnt correspondence includes the receive port corresponding to the transmit port and the node which is the transmission source corresponding to a destination of the received frame.

### CROSS-REFERENCE TO RELATED APPLICATIONS

This patent application is based upon and claims the benefit of priority of the prior Japanese Patent Application No. 2009-258246 filed on Nov. 11, 2009, the entire contents of which are incorporated herein by reference.

### FIELD

A certain aspect of the embodiments discussed herein is corresponding to a relay device, particularly a relay device for relaying frames of Layer 2.

### BACKGROUND

In order to provide a switching hub with loop measures that prevents an increase in traffic due to a loop and improper address relearning without using a control frame, there is provided a switching hub having a plurality of ports for transmitting and receiving frames, a learning means of learning transmission-source MAC addresses of frames while relating them to ports having received the frames, and a relay means of forwarding frames whose destination MAC addresses having been learnt and flooding frames whose destination MAC addresses have not been learnt is equipped with a loop frame removing means of discarding a frame when a frame whose transmission-source MAC address has been learnt is received at a port different from its corresponding port as disclosed in Japanese Laid-open Patent Publication No. 2008-177677.

### SUMMARY

According to an aspect of the embodiment, a relay device includes a port group determining unit configured to associate, when a frame is received by a receive port, group identification information which indicates any one of a plurality of combinations of ports set up in the receive port, with the frame; a relay unit configured to learn a correspondence between the receive port and a node which is a transmission source of the frame to the receive port and determine a transmit port from which the frame is transmitted based on a learning condition including the learnt correspondence, a port group membership memory unit configured to store a membership information piece indicative of the plurality of combinations of ports, a filtering unit configured to limit the transmit port from which the frame is transmitted, and a tagging unit configured to give the group identification information to the frame to be transmitted, wherein the port group determining unit associates the group identification information to the received frame when group identification information has been given to the received frame, and the filtering unit does not limit the transmit port from which the frame is transmitted when the learnt correspondence includes the receive port corresponding to the transmit port and the node which is the transmission source corresponding to a destination of the received frame.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1A illustrates a physical network structure including switch stacking.

FIG. 1B illustrates a logical network structure corresponding to the physical network structure of FIG. 1A.

FIG. 2 illustrates a control of network with spanning tree protocol (STP).

FIG. 3 illustrates a method of controlling frames by including time to live (TTL) into the frames.

FIG. 4 illustrates a method of determining a relay path at the switch where the frame is received first in the switch stack.

FIG. 5 illustrates an example of using link aggregation for switches applied with switch stacking.

FIG. 6 illustrates an example of applying link aggregation to a switch stack using time to live (TTL).

FIG. 7 illustrates a network structure of Embodiment 1.

FIG. 8 illustrates a structure of a switch of Embodiment 1.

FIG. 9 illustrates structures of a frame receiving unit and a frame transmitting unit.

FIG. 10 illustrates an operation example of a switch stack of Embodiment 1.

FIG. 11 illustrates an example of a learning condition about external nodes connected via link aggregation groups in the switch stack of Embodiment 1.

FIG. 12 illustrates a problem in limiting a relay range of a learnt node by a port group in Embodiment 1.

FIG. 13 illustrates an operation of the switch stack when the relay range of the learnt node is not limited in Embodiment 1.

FIG. 14 illustrates an operation example of the switch stack of Embodiment 2.

FIG. 15 illustrates a network structure of Embodiment 2.

FIG. 16 illustrates a network structure of Embodiment 3.

FIG. 17 illustrates a functional configuration of a learning management device.

FIG. 18 illustrates an operation example of a switch stack of Embodiment 3.

FIG. 19 is a flowchart illustrating a procedure in a frame receiving unit of Embodiments 1 to 3.

FIG. 20 is a flowchart illustrating a procedure in a relay unit of Embodiments 1 to 3.

FIG. 21 is a flowchart illustrating a procedure in a frame transmitting unit of Embodiments 1 to 3.

### DESCRIPTION OF EMBODIMENT(S)

Preferred embodiments of the present invention will be explained with reference to accompanying drawings.

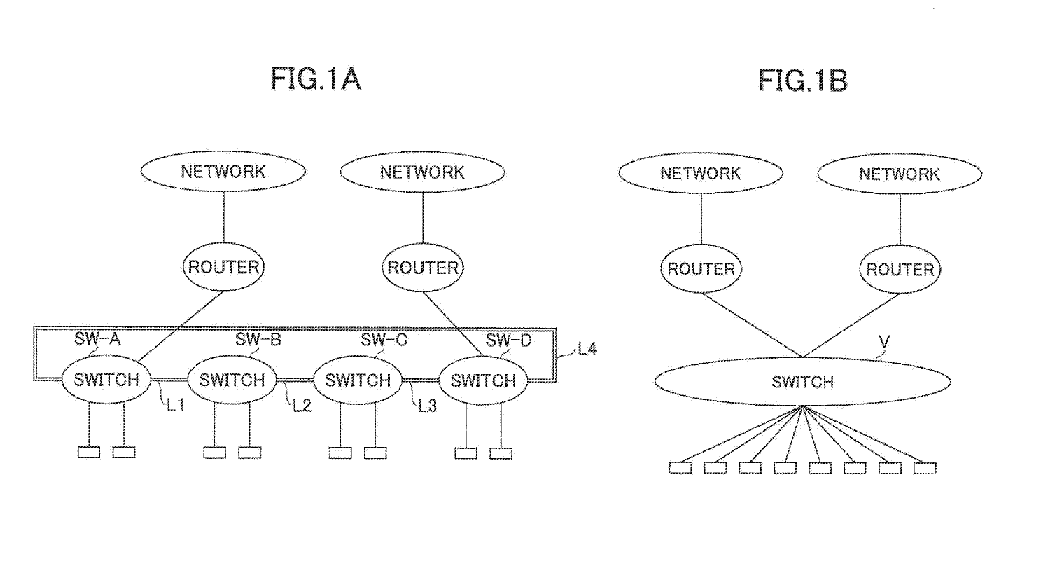

FIG. 1A illustrates a physical network structure including switch stacking. FIG. 1B illustrates a logical network structure corresponding to the physical network structure of FIG. 1A. Stacking of switches such as Layer 2 switches is a technique of connecting plural switches like a stack to appear as a single switch. This switch stacking may be called as virtualization of switches. FIG. 1A illustrates a physical network structure. In FIG. 1A, four switches SW-A through SW-D are connected like a stack via stack links L1 through L4. FIG. 1B illustrates a logical network structure corresponding to the physical network structure of FIG. 1A. Referring to FIG. 1B, plural switches connected like a stack logically appear as a single switch V. In this case, a user can integrally manage four switches SW-A through SW-D as the single switch V.

Redundant paths are ordinarily provided as stack links in switch stacking. The redundant paths make it possible to relay frames even though one of the stack links has a problem. The stack link L4 acts as the redundant path in FIG. 1A. For example, when the stack link L3 between the switch SW-C and the switch SW-D is not used due to a trouble, the switch SW-C and the switch SW-D can mutually communicate by rerouting a frame into a path on a side opposite to the stack link L3 and through the stack link L4.

However, there may occur a broadcast storm when a loop is formed by the redundant paths inside the network if appropriate countermeasures are not provided.

As the countermeasures, the following controls can be considered:

1. A control using spanning tree protocol (STP);

2. A control of a frame by embedding time to live (TTL) into the frame; and

3. A control by determining a relay path at the switch where the frame is received first in the switch stack.

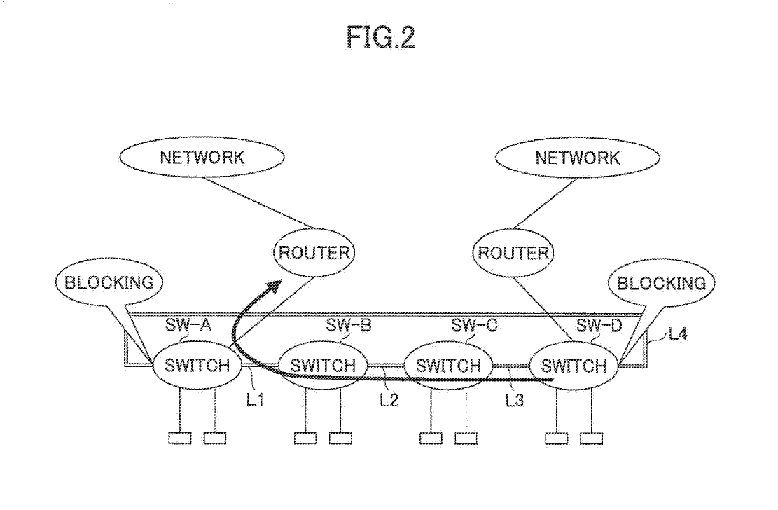

FIG. 2 illustrates a control of a network with spanning tree protocol (STP). With STP, the redundant paths are properly cut or blocked to avoid a network loop from being formed. Referring to FIG. 2, ports toward the stack link L4 are blocked in the switches SW-A and SW-D. With STP, it is possible to establish a communication between the switches SW-A and SW-D by changing over the paths to activate the blocked redundant paths when a communication between the switches SW-A and SW-D is disabled by a problem caused in an unblocked link becomes in trouble.

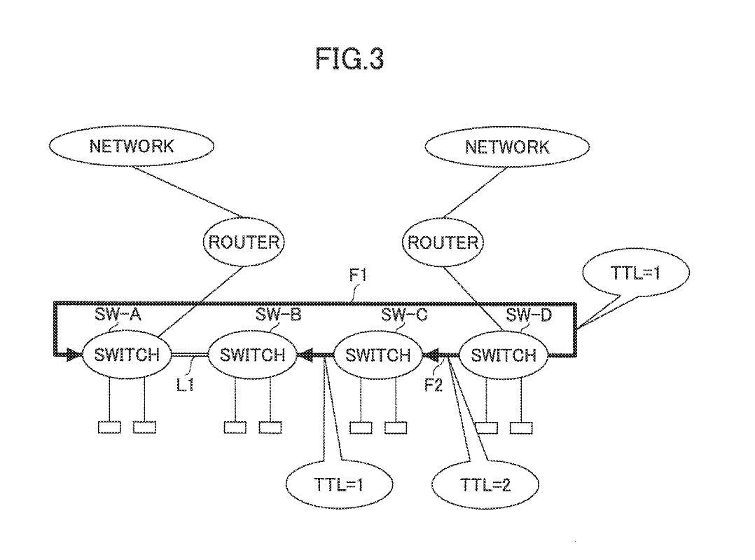

FIG. 3 illustrates a method of controlling frames by including time to live (TTL) into the frames. In this method, TTL is included in the frame, and one is subtracted from the TTL every time the frame passes through the switch. When the TTL becomes zero, the frame is discarded. As a result, it is possible to prevent the frame from infinitely communicating through the network. Thus, it is possible to substantially avoid the loop from continuing. FIG. 3 illustrates an example in which the TTL is 1 in a direction from the switch SW-D to the switch SW-A. FIG. 3 further illustrates an example in which the TTL is 2 in a direction from the switch SW-D to the switch SW-C. The frame F1 is not transmitted to the stack link over the switch SW-A, and the frame F2 is not transmitted to the stack link over the switch SW-B.

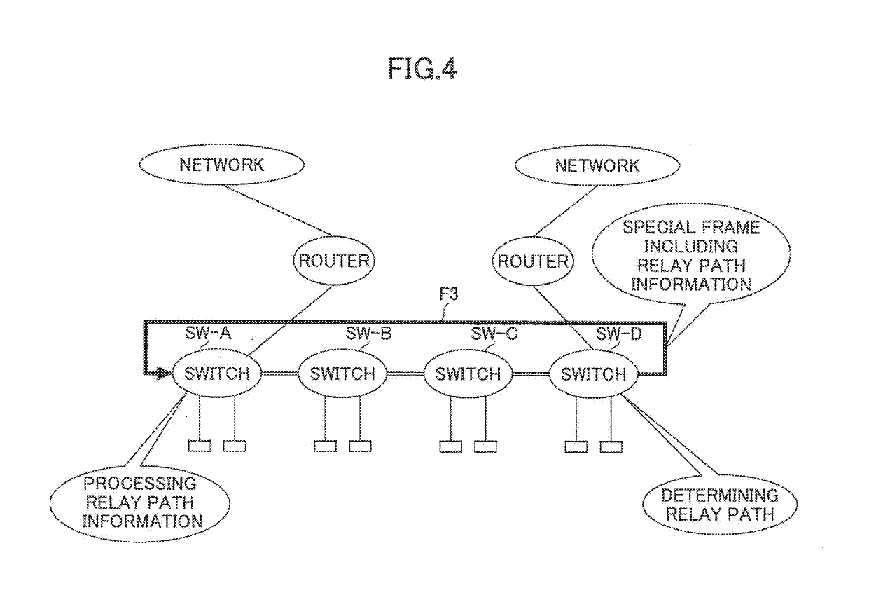

FIG. 4 illustrates a method of determining a relay path at the switch where the frame is received first in the switch stack. In this method, a relay path in a switch stack is determined at a switch which first receives the frame among the switches included in the switch stack, and the frame is transferred in response to the determined relay path. Referring to FIG. 4, the relay path is determined at the switch SW-D. There is illustrated an example in which the frame F3 is transmitted to the switch SW-A. The switch SW-A carries out a relay process in response to the relay path information included in the frame F3.

In the control using spanning tree protocol (STP) illustrated in FIG. 2, a link including the blocked redundant path may not be used. Said differently, since frames other than the controlled frame are not transferred in an ordinary operation, an average hop number to the destination is increased. As a result, loads on links used by the switches in common become high, and the frames become congested.

Further, when TTL is included in the frames, TTL is effective only in switches in compliant with TTL. In an ordinary specification, frames of Layer 2 are not in compliance with TTL.

The frame including relay information is processed by switches which can process frames of a specific type including relay information. For the actual application, the switch has a measure of registering relay paths and searching the relay paths.

On the other hand, there is a technique called “link aggregation” in which plural physical links and lines are grouped to be a single logical link. By using the link aggregation, it is possible to expand a communication range and robustness effected by redundancy. A group of physical links treated as a single logical single link is referred to as “link aggregation group”.

When switch stacking is applied to plural switches, the plural switches are treated as a logical single switch. Therefore, it is possible to set up links belonging to the same link aggregation group through plural switches.

FIG. 5 illustrates an example of using the link aggregation for switches applied with switch stacking.

Referring to FIG. 5, switches SW-B and SW-C among the four switches SW-A through SW-D are connected to an external node A by physically different links L5 and L6. By using link aggregation with the two links L5 and L6, the external node A and a logical switch (i.e. the switch stack) including the switches SW-A through SW-D are treated as connected by a logical single link, namely a link aggregation group G.

When the techniques such as STP and TTL are applied to the switch stack, the link aggregation may not be effectively used. Referring to FIG. 5, since STP blocks a redundant relay path, one of the links belonging to the same link aggregation group G is blocked.

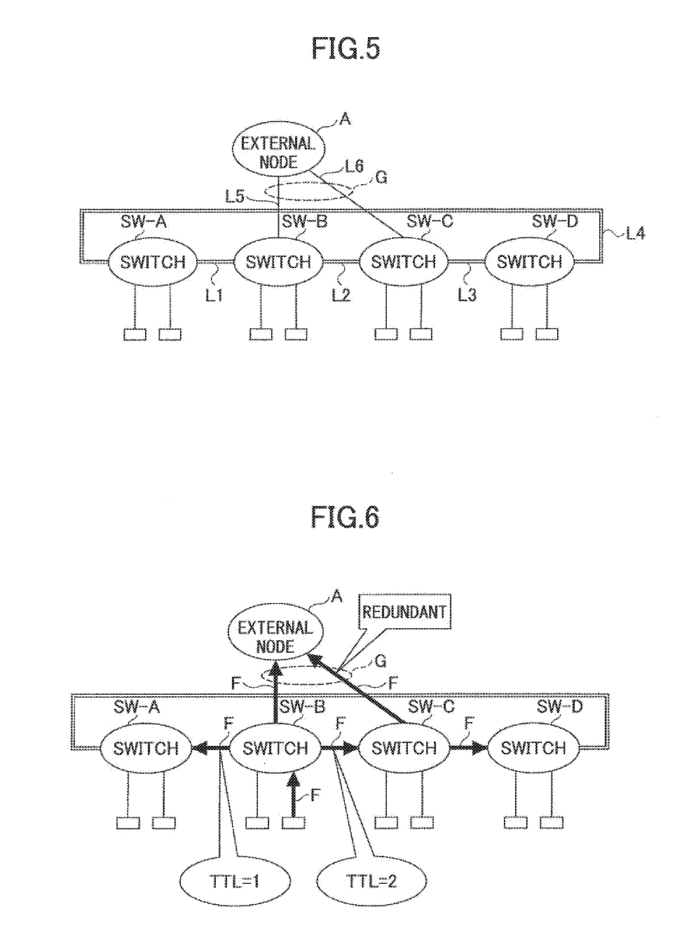

Referring to FIG. 6, when TTL is used, there is a probability that plural frames reach the same node within a range in which TTL is effective. Hereinafter, the terminology “node” includes external nodes, switches, terminals, other Layer 2 devices and so on.

FIG. 6 illustrates an example of applying link aggregation to a switch stack using time to live (TTL). Referring to FIG. 6, a frame F is input into the switch SW-B. The switch SW-B outputs a frame F having a TTL value of 1 to the switch SW-A and outputs a frame F having a TTL value of 2 to the switch SW-C when the frame F is subjected to flooding. In this case, the frame F transferred by the switch SW-B and the frame F transferred by the switch SW-C redundantly reach the external node A.

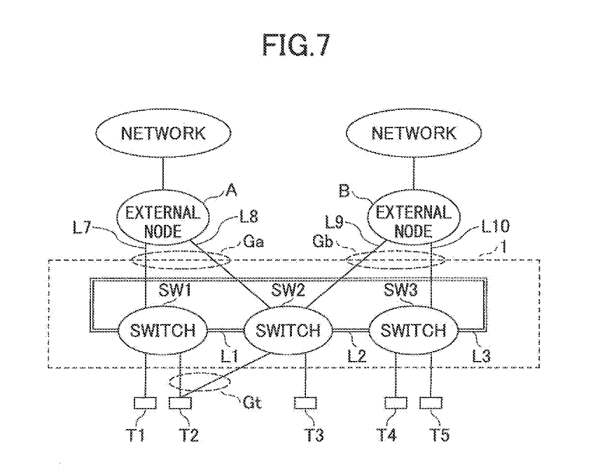

Hereinafter, Embodiment 1 through Embodiment 3 are described with reference to FIG. 7 through FIG. 21. FIG. 7 illustrates a network structure of Embodiment 1.

Referring to FIG. 7, when the switches SW1, SW2 and SW3 are not separately distinguished, the switches are referred to as “switch SW”. The switch stack is treated as the single logical switch. The switches SW may be relay devices such as Layer 2 switches or switching hubs for relaying frames. Referring to FIG. 7, the switches SW are connected like a stack to adjacent switches SW. Hereinafter, lines connecting the switches are referred to as “stack link”. The stack links L1 through L3 are illustrated in FIG. 7. The stack link L3 is a redundant relay path for improving durability against troubles of the network. As a result, the loops are formed by the switches SW1 through SW3.

The external node A is a network device such as a router connected to the switches SW1 and SW2. The external node B is a network device such as a router connected to the switches SW2 and SW3. The external node A is connected to the switch stack 1 via two lines L7 and L8. The external node B is connected to the switch stack 1 via two lines L9 and L10. These lines L7 and L8 are treated as a single logical line, and these lines L9 and L10 are treated as a single logical line. Specifically, the two lines belonging to a link aggregation group Ga is treated as the single logical line. In a similar manner, the two lines belonging to a link aggregation group Gb is treated as the single logical line. Therefore, the external nodes A and B and the switch stack 1 are treated as being connected via corresponding single logical lines.

Terminals T1 through T5 such as a personal computer (PC) are connected to the switches SW1 through SW3. For example, the terminals T1 and T2 are connected to the switch SW1. The terminal T2 is connected to the switch SW2. The line connecting the terminal T2 with the switch SW1 and the line connecting the terminal T2 with the switch SW2 belong to a link aggregation group Gt and are treated as a single logical line.

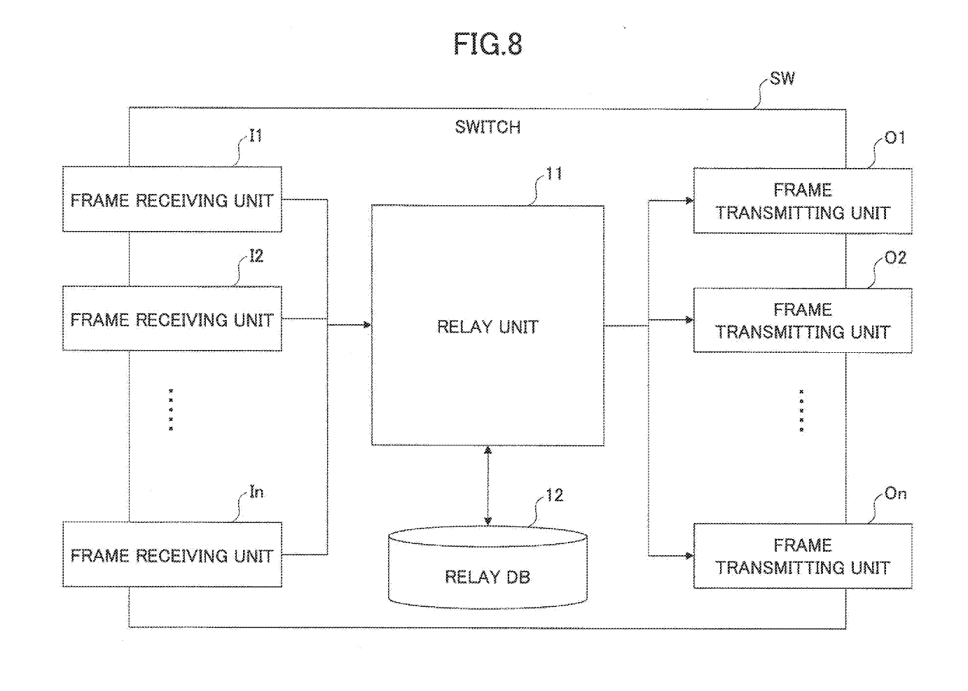

FIG. 8 illustrates a structure of a switch of Embodiment 1. In Embodiment 1, the switches SW of the switch stack 1 includes frame receiving units I1 through In, frame transmitting units O1 through On, a relay unit 11, and a relay database (DB) 12. The number of the frame receiving units is n. The number of the frame transmitting units is n.

The frame receiving units I1 through In are connected to corresponding separate lines and receive frames from the lines. Hereinafter, when the frame receiving units I1 through In are not distinguished, the frame receiving units are referred to as frame receiving unit I. The frame transmitting unit O1 through On are connected to corresponding separate lines and transmit frames from the lines. Hereinafter, when the frame transmitting units O1 through On are not distinguished, the frame transmitting units are referred to as frame transmitting unit O. The frame receiving unit I and the frame transmitting unit O having the same lowest digit are connected to the same line. For example, the frame receiving unit I1 and the frame transmitting unit O1 are connected to the same line.

The relay unit 11 carries out basic functions of the switch SW such as a relay process, a node learning process, or the like. Specifically, the relay unit 11 records correspondence information between a transmission-source MAC address of a received frame which has been received by the frame receiving unit I and identification of a port corresponding to the frame receiving unit I which has received the frame into the relay DB 12. When the correspondence information between the destination MAC address of the received frame and the port is registered in the relay DB12, the relay unit 11 makes a frame transmit from the frame transmitting unit O corresponding to the port. The relay unit 11 carries out flooding when the corresponding information between the destination MAC address of the received frame and the port is not registered in the relay DB 12. This flooding is carried out by outputting with the relay unit 11 the received frames to all the frame transmitting units O other than the frame transmitting unit O corresponding to the frame receiving unit I which receives the frame when the destination of the received frame is not registered in the relay unit 12 because it is unknown which destination node is connected to which port.

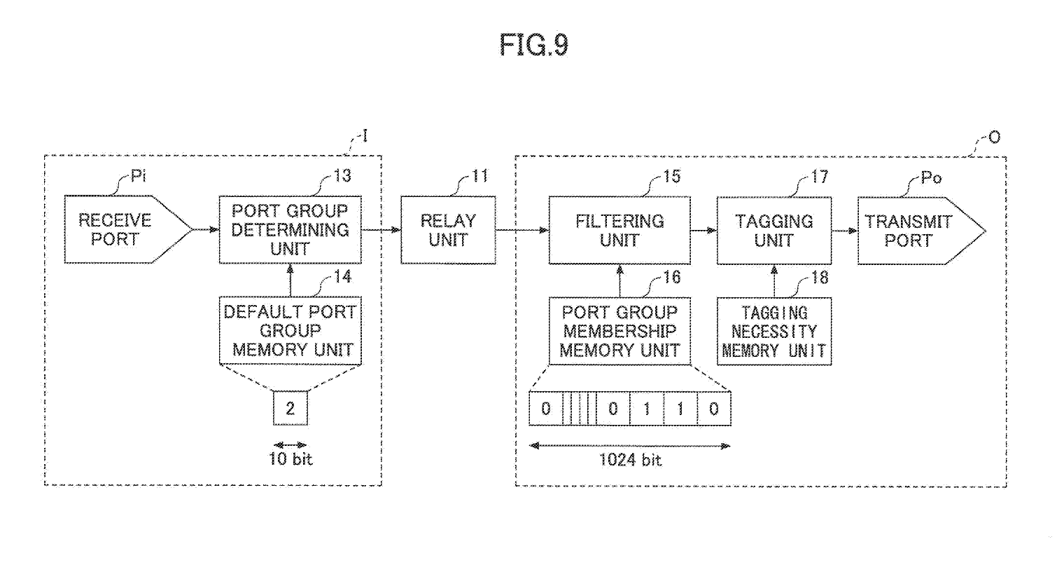

Detailed description of the frame receiving unit I and the frame transmitting unit O is given next. FIG. 9 illustrates structures of the frame receiving unit I and the frame transmitting unit O.

Referring to FIG. 9, the frame receiving unit I includes a receive port Pi, a port group determining unit 13, a default port group memory unit 14, or the like.

The receive port Pi receives a frame from a line. A port group determining unit 13 is a circuit for determining the group number of a port group given to the received frame. The port group is a concept of identifying plural combinations (groups) of transmit ports Po included in the switches SW of the switch stack 1. The group number is information for distinguishing or discriminating whether the port groups are the same or different. The port group determining unit 13 determines the group number to be given to the received frame using a default port group memory unit 14. The default port group memory unit 14 may be a register (recording medium) having a memory capacity of 10 bits. The default port group memory unit 14 stores one preset group number previously stored in the frame receiving unit I to which the default port group memory unit 14 belongs. One group number is set in correspondence with one of the frame receiving units I. FIG. 9 illustrates an example that “2” is set as the group number. However, there is a case where the tag including the group number is given to the received frame as described later. When the tag is given to the received frame, the port group determining unit 13 determines the group number corresponding to the received frame as the group number including the tag. The received frame of which group number is determined by the port group determining unit 13 is input into the relay unit 11. The group number determined by the port group determining unit 13 is administrated in association with the received frame.

On the other hand, one of the frame transmitting units O includes a filtering unit 15, a port group membership memory unit 16, a tagging unit 17, a tagging necessity memory unit 18, and a transmit port Po. The received frame is input from the relay unit 11 to the filtering unit 15 of the frame transmitting unit O corresponding to the port determined as the destination of the received frame. The group number determined by the port group determining unit 13 is input to the filtering unit 15 along with the received frame. The filtering unit 15 is a circuit which carries out filtering of the received frame using the input group number and the port group membership memory unit 16. This filtering is a process of limiting the received frames to only what is to be transmitted. The port group membership memory unit 16 is a register or a recording medium having a memory capacity of 1024 bits and stores the group number of the port group to which the frame transmitting unit O belongs. Specifically, each of the port group membership memory units 16 corresponds to the corresponding port group. The N-th bit of the port group membership memory units 16 corresponds to the group number N. The bit number “1” designates that the frame transmitting unit O belongs to the port group corresponding to the bit. The bit number “0” designates that the frame transmitting unit O does not belong to the port group corresponding to the bit. Referring to FIG. 9, the 1st and 2nd bits are “1”. Therefore, it is known that the frame transmitting unit O belongs to the group 1 and the group 2. In Embodiment 1, it is possible to store whether the port group membership memory unit 16 belongs to port groups as many as 1024. The reason why the default port group memory unit 14 has 10 bits is to enable expression of the group numbers as many as 1024 at a maximum. Said differently, the memory capacities (bit number) of the default port group memory unit 14 and the port group membership memory unit 16 may be determined by the group number which can be defined. Specifically, the port numbers of the ports of the switch stack 1 connectable to the external node are the maximum value of the groups which can be defined.

The filtering unit 15 determines that the received frame is subjected to transmission when the bit corresponding to the input group number in the port group membership memory unit 16 is “1”. The filtering unit 15 transmits the received frame determined to be transmitted and the input group number into the tagging unit 17. On the other hand, the filtering unit 15 discards the received frame when the bit corresponding to the input group number in the port group membership memory unit 16 is “0”. Therefore, the received frame is not transmitted from the frame transmitting unit O.

The tagging unit 17 gives data indicative of the group number input from the filtering unit 15 to the received frame which is input from the filtering unit 15. In Embodiment 1, the data indicative of the group number given to the received frame by the tagging unit 17 are referred to as “tag”. The tag is given as a part of the frame so that the tag and the received frame are integrally communicated. However, the tag is given in a case where it is indicated in the tagging necessity memory unit 18 that the tag is to be given to the received frame. The tagging necessity memory unit 18 may be a register (recording medium) having a memory capacity of one bit. It is indicated whether the tag is to be given using the one bit. The number “1” designates the tag is to be given, and the number “0” designates the tag is not given. The number “1” is stored in the tagging necessity memory unit 18 of the frame transmitting unit O connected to internal lines of the switch stack 1 (namely, any one of stack links L1 through L3). Meanwhile, “0” is recorded in the tagging necessity memory unit 18 of the frame transmitting unit O connected to the external line of the switch stack 1. Since the tag is information effective only inside the switch stack 1, it is useless or not preferable to give a tag to a frame transferred to the outside of the switch stack 1. The transmission port Po transmits the received frame input from the tagging unit 17 to the lines.

Referring to FIG. 9, values set in the default port group memory unit 14, the port group membership memory unit 16, and the tagging necessity memory unit 18 may be set or recorded via a button included in the switch SW or by transmitting a control frame to the switch SW.

As described, it becomes possible to separate the frame receiving units I and the frame transmitting units O of the switches SW into groups using a concept of “port group”. The separations of the frame receiving units I and the frame transmitting units O into the groups are substantially equivalent to separation of the receive ports Pi and the transmit ports Po into groups. Next, the ports are separated on their receiving sides in further describing Embodiment 1. When the terminology “port” is used, there is no discrimination between the receive port Pi and the transmit port Po.

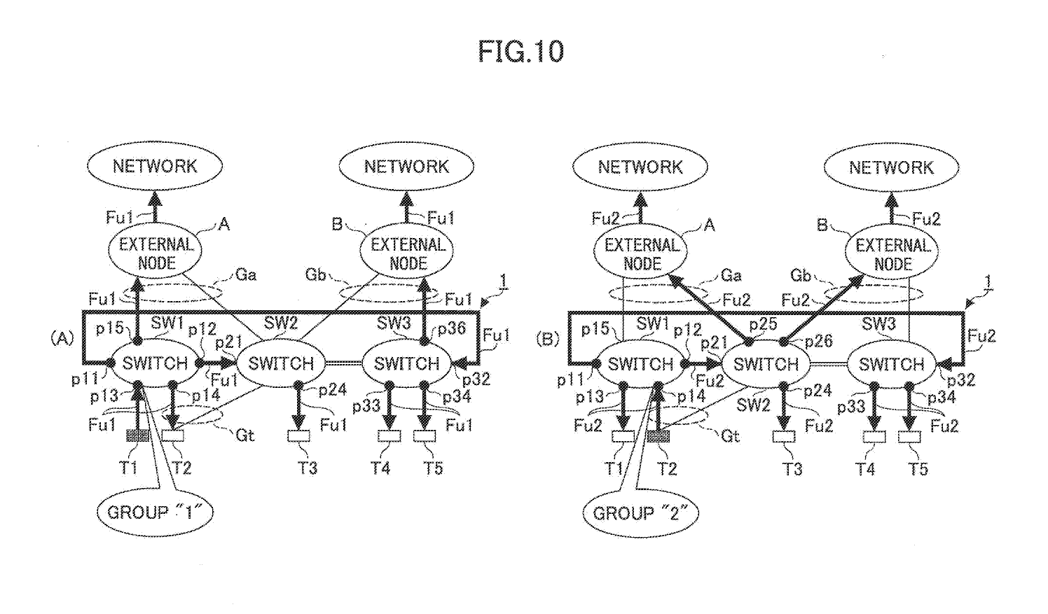

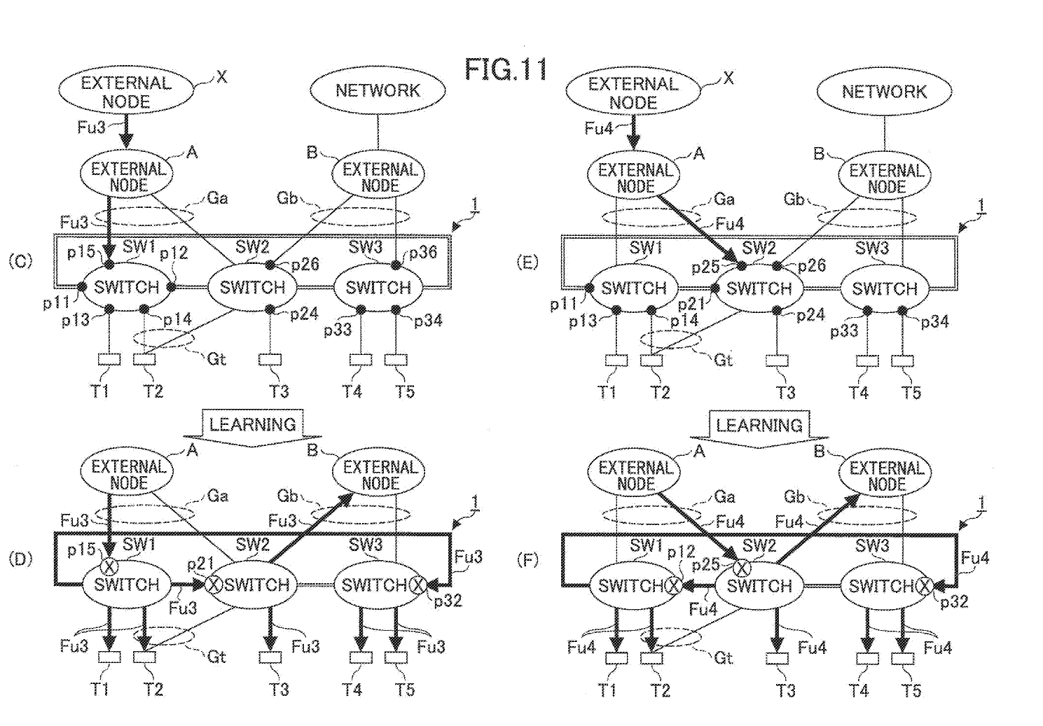

When the switch SW has the structure illustrated in FIG. 9, it becomes possible to control the relay path as illustrated in FIG. 10.

FIG. 10 illustrates an operation example of the switch stack of Embodiment 1.

Referring to (A) of FIG. 10, an operation example of the switch stack 1 is illustrated. The operation example is in a case where a frame Fu1 of which destination is unknown is received from a terminal T1 by a receive port corresponding to a port p13 of the switch SW1. The frame of which destination is unknown means that the destination MAC address is not learnt nor registered in the relay DB 12. A number “1” is recorded in the default port group memory unit 14 in association with the receive port Pi corresponding to the port P13. The ports marked by black circles designate the transmit ports Po belonging to the group 1 of which group number is “1”. The transmit port Po belonging to the group 1 is the transmit port Po belonging to the frame transmit unit O.

Specifically, the transmit ports Po corresponding to the ports p11, p12, p13, p14 and p15 of the switch SW1, the port p24 of the switch SW2, and the ports p33, p34 and p36 of the switch SW3 belong to the group 1.

In this case, the group number corresponding to the frame Fu1 is determined as “1” by the port group determining unit 13 corresponding to the port p13. Subsequently, the relay unit 11 carries out flooding since the destination of the frame Fu1 is unknown. The frame Fu1 is discarded by the filtering unit 15 in the frame transmitting unit O which does not belong to the group 1. Therefore, the frame Fu1 is transmitted from the transmit port Po corresponding to the ports p11, p12, p14 and p15 belonging to the group 1. Tags indicative of the group 1 are added to the frames by the tagging units 17 corresponding to the transmit ports which transmit the frames Fu1. However, the ports p14 and p15 are connected to the line of the external node. Therefore, the values corresponding to the ports p14 and p15 in the tagging necessity memory unit 18 are set as “0”. As a result, the tagging units 17 corresponding to the ports p14 and p15 do not give a tag to the frame Fu1.

The switch SW2 receives the frame Fu1 transmitted from the port p12 of the switch SW1 via the receive port Pi corresponding to the port p21. The port group determining unit 13 corresponding to the port p21 determines that the group number of the received frame Fu1 is “1”. This is because the frame Fu1 has a tag indicative of the group number “1”. Subsequently, the relay unit 11 of the switch SW2 carries out flooding since the destination of the frame Fu1 is unknown. As a result, the frame Fu1 is transmitted from the transmit port Po corresponding to the port p24 belonging to the group 1. The port p24 is connected to the line of the external node. Therefore, a tag is not given to the frame Fu1 transmitted from the transmit port Po. More specifically, the frame Fu1 is transmitted after the tag given to the frame Fu1 is removed. As described above, a phrase in which a tag is not given to a frame includes removing the tag once given to the frame.

The switch SW3 receives the frame Fu1 transmitted from the port p11 of the switch SW1 via the receive port Pi corresponding to the port p32. The port group determining unit 13 corresponding to the port p32 determines that the group number of the received frame Fu1 is “1”. This is because the frame Fu1 has a tag indicative of the group number “1”. Subsequently, the relay unit 11 of the switch SW3 carries out flooding since the destination of the frame Fu1 is unknown. However, the frame Fu1 is discarded by the filtering unit 15 in the frame transmitting unit O which does not belong to the group 1. As a result, the frame Fu1 is transmitted from the transmit ports Po corresponding to the ports p33, p34 and p36 belonging to the group 1. The ports p33, p34, and p36 are connected to the line of the external node. Therefore, a tag is not given to the frame Fu1 transmitted from the transmit port Po corresponding to the ports p33, p34, and p35.

Referring to (B) of FIG. 10, an operation example of the switch stack 1 is illustrated. The operation example is in a case where the frame Fu2 of which destination is unknown is received from a terminal T2 by a receive port Pi corresponding to the port p14 of the switch SW1. A number “2” is recorded in association with the receive port Pi corresponding to the port p14 in the default port group memory unit 14. The ports marked by black circles in (B) of FIG. 10 designate the transmit ports Po belonging to the group 2 of which group number is “2”. The transmit port Po belonging to the group 2 is included in the frame transmit unit O including the port group membership memory unit 16 in which the second bit is “1”.

Specifically, the transmit ports Po corresponding to the ports p11, p12, p13 and p14 of the switch SW1, the ports p24, p25 and p26 of the switch SW2, and the ports p33 and p34 of the switch SW3 belong to the group 2.

In this case, the group number corresponding to the frame Fu2 is determined as “2” by the port group determining unit 13 corresponding to the port p14. Subsequently, the relay unit 11 of the switch SW1 carries out flooding since the destination of the frame Fu2 is unknown. However, the frame Fu2 is discarded by the filtering unit 15 in the frame transmitting unit O which does not belong to the group 2. Therefore, the frame Fu2 is transmitted from the transmit port Po corresponding to the ports p11, p12 and p13 belonging to the group 2. Tags indicative of the group 2 are given to the frames Fu2 transmitted from the transmit port Po corresponding to the ports p11 and p12.

The switch SW2 receives the frame Fu2 transmitted from the port p12 of the switch SW1 via the receive port Pi corresponding to the port p21. The port group determining unit 13 corresponding to the port p21 determines that the group number of the received frame Fu2 is “2”. This is because the frame Fu2 has a tag indicative of the group number “2”. Subsequently, the relay unit 11 of the switch SW2 carries out flooding since the destination of the frame Fu2 is unknown. However, the frame Fu2 is discarded by the filtering unit 15 in the frame transmitting unit O which does not belong to the group 2. As a result, the frame Fu2 is transmitted from the transmit ports Po corresponding to the ports p24, p25 and p26 belonging to the group 2. Tags are not given to the frame Fu2 transmitted from the transmit port Po since the ports p24, p25 and p26 are connected to the line of the external node.

The switch SW3 receives the frame Fu2 transmitted from the port p11 of the switch SW1 via the receive port Pi corresponding to the port p32. The port group determining unit 13 corresponding to the port p32 determines that the group number of the received frame Fu2 is “2”. This is because the frame Fu2 has a tag indicative of the group number “2”. Subsequently, the relay unit 11 of the switch SW3 carries out flooding since the destination of the frame Fu2 is unknown. However, the frame Fu2 is discarded by the filtering unit 15 in the frame transmitting unit O which does not belong to the group 2. As a result, the frame Fu2 is transmitted from the transmit ports Po corresponding to the ports p33 and p34 belonging to the group 2. Tags are not given to the frame Fu2 transmitted from the transmit port Po since the ports p33 and p34 are connected to the line of the external node.

Referring to FIG. 10, it is possible to control or limit a relay range (relay path) of the received frames by separating the transmit ports Po to groups in Embodiment 1. As a result, it is possible to restrict transmission of excessive frames to the nodes.

Therefore, a use of link aggregation is enabled while properly restricting a broadcast storm caused by existence of a redundant relay path in the switch stack 1 and existence of a redundant relay path in using the link aggregation. Further, it is possible to diminish a drop of an average hop number of the frames and relax a load of the stack links. Thus, a high network performance is obtainable.

Further, it is possible to make only one of plural lines belonging to the same link aggregation group be used for transferring the same frame. Specifically, a line used for transferring the frame Fu1 and a line used for transferring the frame Fu2 are different in respective link aggregation groups Ga and Gb. Therefore, it is also possible to share loads as the feature of link aggregation.

In order to achieve the above described effects, the ports are separated into the groups so as to satisfy the following conditions.

(1) Avoiding redundant relay paths in each group.

(2) Evenly use plural lines when the plural lines bound for one node

The redundant relay path in the above condition (1) exists when plural relay paths exist between a certain pair of ports. This means that a loop is formed in the switch stack 1 by the relay paths of the frames. Therefore, it is possible to paraphrase the above condition (1) as omission of redundant relay paths in every group.

In order to satisfy the above condition (2), the port group in which the transmit ports Po belong may be determined as follows. At first, a serial number n is sequentially given to receive ports Pi connected to the lines of the external nodes. Hereinafter, the receive port Pi to which the serial number n is given is referred to as a receive port n. Subsequently, serial numbers are given from zero through S to the transmit ports Po respectively connected to the lines as many as S which belong to the same aggregation group. Hereinafter, the transmission ports to which the serial numbers are given are referred to as the transmit ports m. Group numbers recoded in the default port group memory unit 14 corresponding to the receive port n satisfying (n mod S)=m are added to the port group membership memory unit 16 of the transmit port m. The “mod” is a function of outputting a reminder. For example, two lines belong to the link aggregation group Ga. Therefore, the transmit port Po corresponding to the port p15 connected to one of the lines is referred to as transmit port 0, and the transmit port Po corresponding to the port p15 connected to the other line is referred to as transmit port 1. The serial numbers are given to the receive port Pi corresponding to the port p13 connected to the external node as “0”, to the receive port Pi corresponding to the port p14 as “1”, and to the receive port Pi corresponding to the port p15 as “2”. In this case, the port group membership memory units 16 of the transmit ports Po are set to have a group number recorded in the default port group memory units 14 of the receive ports Pi corresponding to the ports p13 and p15 having the serial numbers n satisfying (n mod 2)=0. In a similar manner, the port group membership memory unit 16 of the transmit port 1 is set to have a group number recorded in the default port group memory unit 14 of the receive port Pi corresponding to the port p14 having the serial numbers n satisfying (n mod 2)=1.

In Embodiment 1, a frame of which destination is one learnt node is omitted from an object of limiting the relay range using port groups. Hereinafter, the reason is explained.

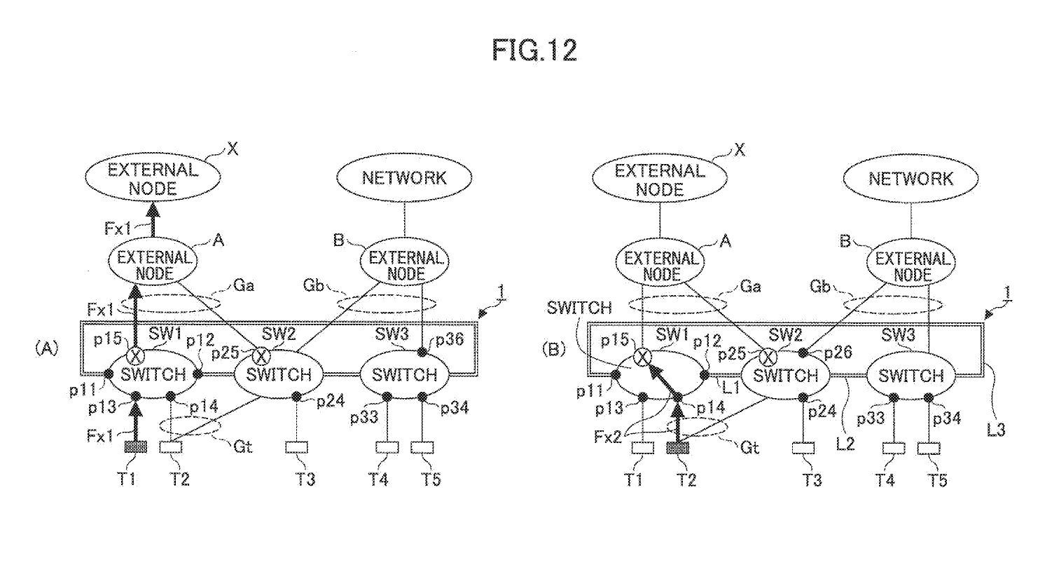

FIG. 11 illustrates an example of a learning condition about external nodes connected via the link aggregation groups in the switch stack of Embodiment 1. Referring to FIG. 11, the external node X is connected to the side of the external node A.

Referring to (C) of FIG. 11, the switch stack receives a frame Fu3 of which transmission source is the external node X and of which destination is unknown. Any one of the lines belonging to the link aggregation group Ga is selected and used for transferring the frame Fu3. Referring to (c) of FIG. 11, an example in which the line is connected to the port p15 of the switch SW1 is illustrated. A number “3” is recorded in association with the receive port Pi corresponding to the port P15 in the default port group memory unit 14. The ports marked by black circles in (C) of FIG. 11 designate the transmit ports Po belonging to the group 3 of which group number is “3”.

Referring to (D) of FIG. 11, the frame Fu3 is subjected to flooding from the transmit port Po belonging to the port group 3 in a similar manner to the process illustrated in FIG. 10, and the switches SW learn the external nodes X. Said differently, the characters “X” in circles indicative of ports mean that correspondence information between the ports and the MAC addresses of the external nodes X is registered in the relay DB 12. Specifically, the port p15 is registered as the transmit port Po corresponding to the external node X in the relay DB 12 of the switch SW1, the port p21 is registered as the transmit port Po corresponding to the external node X in the relay DB 12 of the switch SW2, the port p32 is registered as the transmit port Po corresponding to the external node X in the relay DB 12 of the switch SW3 the transmit port Po corresponding to the external node X.

Thereafter, when a frame Fu4 of which transmission source is the external node X and of which destination is unknown is received by the switch stack 1 as illustrated in (E) of FIG. 11 after the learning condition illustrated in (D) of FIG. 11. Comparing (E) with (C) in FIG. 11, different lines are used. This is because the line included in the link aggregation group Ga and to be used dynamically change. As a result, the frame Fu4 is received by the receive port Pi corresponding to the port p25 of the switch SW2.

Once the learning is carried out, nodes such as external nodes, switches, terminals, and Layer 2 devices and corresponding ports of the switch SW may be mated so as to correspond not only when the switch SW receives a frame from the nodes but also when the switch SW transmits a frame to the nodes. Said differently, the learnt correspondence may be a receiving and transmitting correspondence.

A number “4” is recorded in association with the receive port Pi corresponding to the port p25 in the default port group memory unit 14. The ports marked by black circles in (E) of FIG. 11 designate the transmit ports Po belonging to the group 4 of which group number is “4”.

Referring to (F) of FIG. 11, the frame Fu4 is subjected to flooding from the transmit port Po belonging to the port group 4, and the external nodes X are learnt by the switches SW. A learning condition of (F) of FIG. 11 is different from the learning condition of (D) of FIG. 11. This is because, in an ordinary switch, old learning is removed when new learning is carried out for the same node. Specifically, the port p12 is learnt as the transmit port Po corresponding to the external node X in the switch SW1, and the port p25 is learnt as the transmit port Po corresponding to the external node X in the switch SW2.

When the frame of which destination is unknown is received from the external node X via the relay path in (C) of FIG. 11 after the learning condition of (F) of FIG. 11, the learning condition of the external node X becomes as illustrated in (D) of FIG. 11. As described, the learning condition for the external node X becomes selective for any one of (C) and (D) or conflicts between (C) and (D) of FIG. 11. As a result, the problem illustrated in FIG. 12 occurs.

FIG. 12 illustrates the problem in limiting a relay range of a frame by a port group in Embodiment 1. The frame has learnt an external node as the destination. (A) and (B) of FIG. 12 occur after the learning condition illustrated in (D) of FIG. 11.

Referring to (A) of FIG. 12, the frame Fx1 from a terminal T1 to the external node X is received by the receive port Pi corresponding to the port p13 of the switch SW1. In a similar manner to (A) of FIG. 10, the group number related to the frame Fx1 is determined as “1” by the port group determining unit 13 corresponding to the port p13. In a similar manner to (A) of FIG. 10, the group number related to the frame Fx1 is determined as “1” by the port group determining unit 13 corresponding to the port p13. Subsequently, the relay unit 11 of the switch SW1 determines the transmit port Po corresponding to the port p15 as the destination of the frame Fx1 based on a learnt content recorded in the relay DB 12. The relay unit 11 transmits the frame Fx1 and the group number “1” into the filtering unit 15 corresponding to the port p15. In a similar manner to (A) of FIG. 10, the transmit port Po corresponding to the port p15 belongs to the group 1. Therefore, the frame Fx1 is not discarded and is transmitted from the transmit port Po corresponding to the port p15. As a result, the frame Fx1 is normally relayed in the external node X.

Referring to (B) of FIG. 12, a frame Fx2 from a terminal T2 to the external node X is received by the receive port Pi corresponding to the port p14 of the switch SW1. In a similar manner to (B) of FIG. 10, the group number related to the frame Fx2 is determined as “2” by the port group determining unit 13 corresponding to the port p14. Subsequently, the relay unit 11 of the switch SW1 determines the transmit port Po corresponding to the port p15 as the destination of the frame Fx2 based on a learnt content recorded in the relay DB 12. The relay unit 11 transmits the frame Fx2 and the group number “2” to the filtering unit 15 corresponding to the port p15. However, the transmit port Po corresponding to the port p15 belongs to the group 1 and does not belong to the group 2. Therefore, the filtering unit 15 discards the frame Fx2. As a result, the frame Fx2 is not relayed in the external node X.

Therefore, the switch SW of Embodiment 1 does not limit a relay range based on the port group for the frame of which destination is the learnt node. Specifically, the relay unit 11 transmits information (hereinafter, referred to as filtering unnecessity instruction) indicating that filtering is unnecessary to the filtering unit 15 corresponding to the transmit port Po together with a frame when the number of the transmit port Po is determined to be one based on the relay DB 12. The filtering unit 15 makes the frame pass through the filtering unit 15 without filtering using the port group membership memory unit 16 when the filtering unnecessity instruction is input. Thereafter, a tag is given to the frame by the tagging unit 17 when the tag is to be given and the frame with the tag is transmitted from the transmit port Po. Various types and modes of the filtering unnecessity instruction may be realized.

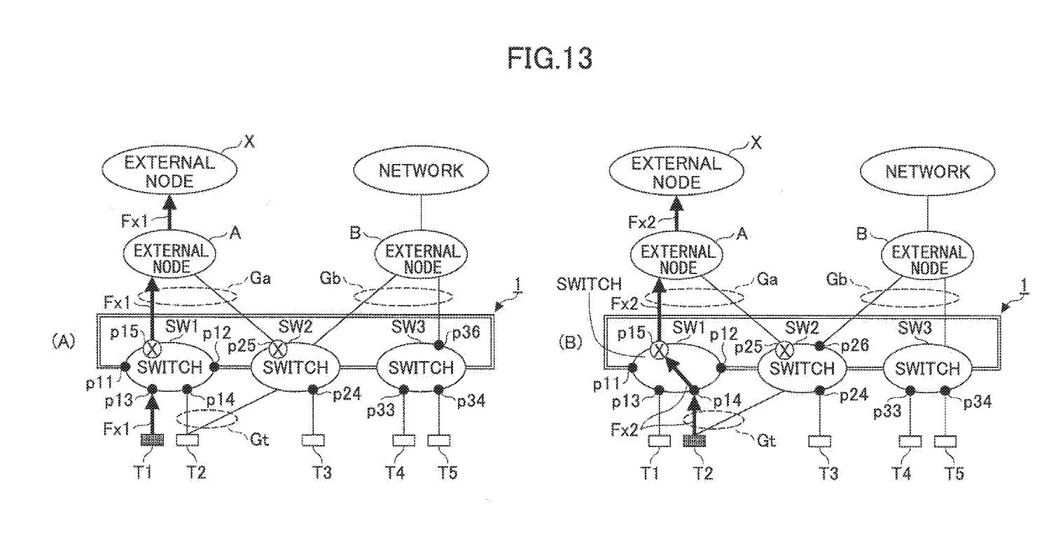

With the operation of the switches SW as described above, the switch stack 1 is operated as illustrated in FIG. 13 in a similar manner to the receipt of the frames Fx1 and Fx2 of FIG. 12.

FIG. 13 illustrates an operation of the switch stack when a relay range of a frame of which destination is a learnt node is not limited in Embodiment 1. (A) and (B) of FIG. 13 correspond to (A) and (B) of FIG. 12. Differences of FIG. 13 from FIG. 12 are described.

Referring to (A) of FIG. 13, the destination of the frame Fx1 received from the terminal T1 is one of the external nodes X, and the one of the external nodes X has been learnt by the switch SW1. Therefore, the relay unit 11 of the switch SW1 transmits the filtering unnecessity instruction to the filtering unit 15 corresponding to the port p15 together with the frame Fx1. The filtering unit 15 allows the frame Fx1 to pass through based on the filtering unnecessity instruction. As a result, the frame Fx1 is transmitted from the transmit port Po related to the port p15.

Referring to (B) of FIG. 13, the destination of the frame Fx2 received from the terminal T2 is one of the external nodes X, and the one of the external nodes X has been learnt by the switch SW1. Therefore, the relay unit 11 of the switch SW1 transmits the filtering unnecessity instruction to the filtering unit 15 corresponding to the port p15 together with the frame Fx2. The filtering unit 15 allows the frame Fx2 to pass through based on the filtering unnecessity instruction without filtering the frame Fx2. As a result, the frame Fx2 is transmitted from the transmit port Po corresponding to the port p15.

As described, the frames of which destinations are the learnt nodes are properly relayed.

The limitation using the port groups is released when a destination of a frame is a learnt external node. Therefore, relay ranges of a frame determined as a subject of flooding by the relay unit (namely, a frame of which destination is unknown) or a frame of which destination is plural are limited by a port group as described in Embodiment 1.

### Embodiment 2

The problem described in reference to FIG. 12 may be solved by another method. The other method is different from the method of releasing the limitation using the port groups in the relay range of the frame of which destination is the learnt node. In Embodiment 2, a frame of which destination is one learnt node may be an object of limiting the relay range using the port groups. Differences of Embodiment 2 from Embodiment 1 are described. Features of Embodiment 2 which are not specifically described are substantially the same as those of Embodiment 1.

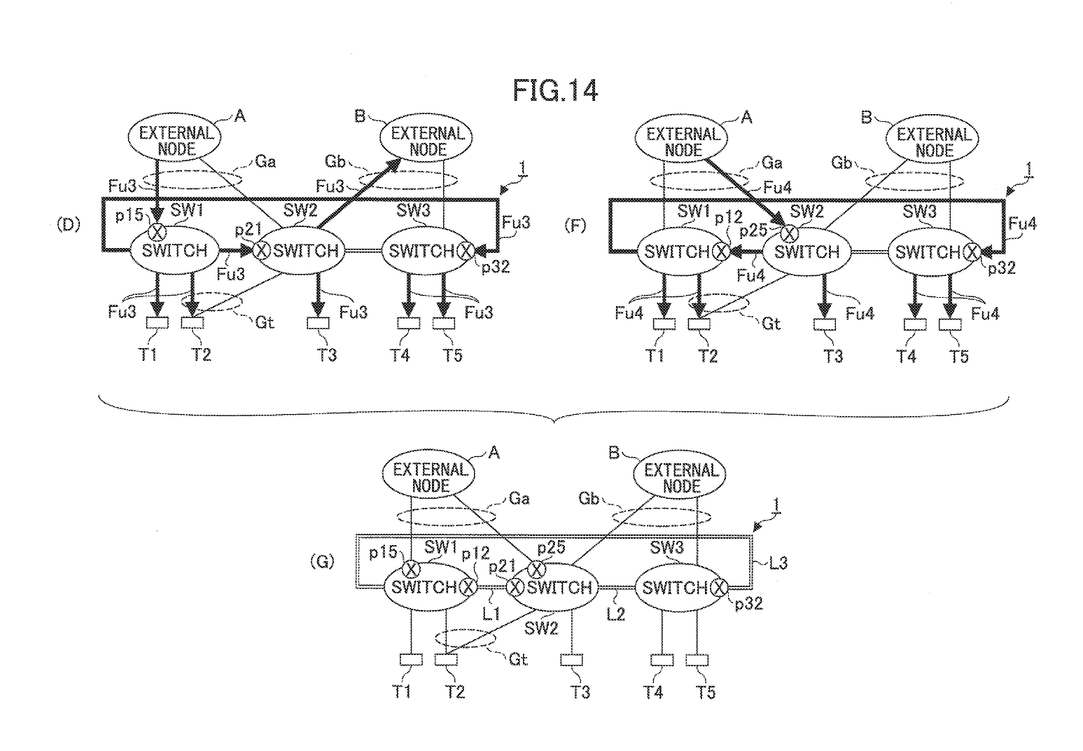

FIG. 14 illustrates an operation example of a switch stack of Embodiment 2.

Referring to (D) and (F) of FIG. 14, two ways of learning conditions of the external nodes X are illustrated. The switches SW of Embodiment 2 are different from known ordinary switches. When there are plural learning conditions for the same external node, the learning conditions are integrated by a logical add calculation. The same external nodes are additionally or repeatedly learnt. As illustrated in (G) of FIG. 14, the ports p15 and p12 of the switch SW1, the ports p21 and p25 of the switch SW2, and the port p32 of the switch SW3 are learnt as the ports corresponding to the external node X.

Specifically, a relay unit 11 and a relay DB 12 allow a correspondence between plural ports and one node. Therefore, if a frame is relayed to realize a learning condition illustrated in (F) of FIG. 14 after the learning condition illustrated in (D) of FIG. 14, the learning condition illustrated in (D) of FIG. 14 is not removed from the relay DB 12 and the learning condition illustrated in (F) of FIG. 14 is newly added to the relay DB 12.

As a result, even though the frame of which destination is the one external node is released from the limitation in the relay range using the port groups, the frame can be properly relayed. For example, when the frame Fx2 illustrated in (B) of FIG. 12 is received by the port p14, the frame Fx2 can be relayed in the external node X. In this case, the group number corresponding to the frame Fx2 is determined as “2” by the port group determining unit 13 corresponding to the port p14. The relay unit 11 of the switch SW1 determines the transmit ports Po corresponding to the ports p12 and p15 as the destination of the frame Fx2 based on the learnt content recorded in the relay DB of the switch SW1. Based on the determination, the relay unit 11 transmits the frame Fx2 and the group number “2” into the filtering units 15 corresponding to the ports p12 and p15. Since the port p15 does not belong to the group 2, the input frame Fx2 is discarded by the filtering unit 15 corresponding to the port p15. Since the port p12 belongs to the group 2, the filtering unit 15 corresponding to the port p12 allows the frame Fx2 to pass through the filtering unit 15. Since the port p12 is connected to the stack link L1, a tag indicative of the group number “2” is given to the frame Fx by the tagging unit 17. The frame Fx2 to which the tag is given is transmitted from the transmit port Po corresponding to the port p12 and is received by the receive port Pi corresponding to the port p21.

The port group determining unit 13 corresponding to the port p21 determines the group number “2” indicated by the tag given to the frame Fx2 as the group number for the frame Fx2. Subsequently, the relay unit 11 of the switch SW2 determines that the destination of the frame Fx2 is the transmit port Po corresponding to the port p25. The port p25 belongs to the group 2. Therefore, the frame Fx2 is transmitted from the transmit port Po corresponding to the port p25 without being discarded by the filtering unit 15 corresponding to the port p25. As a result, the frame Fx2 is relayed by the external node X.

As described, Embodiment 2 makes it possible to properly relay with an external node connected via a link aggregation group without releasing a limit in a relay range of frames using port groups.

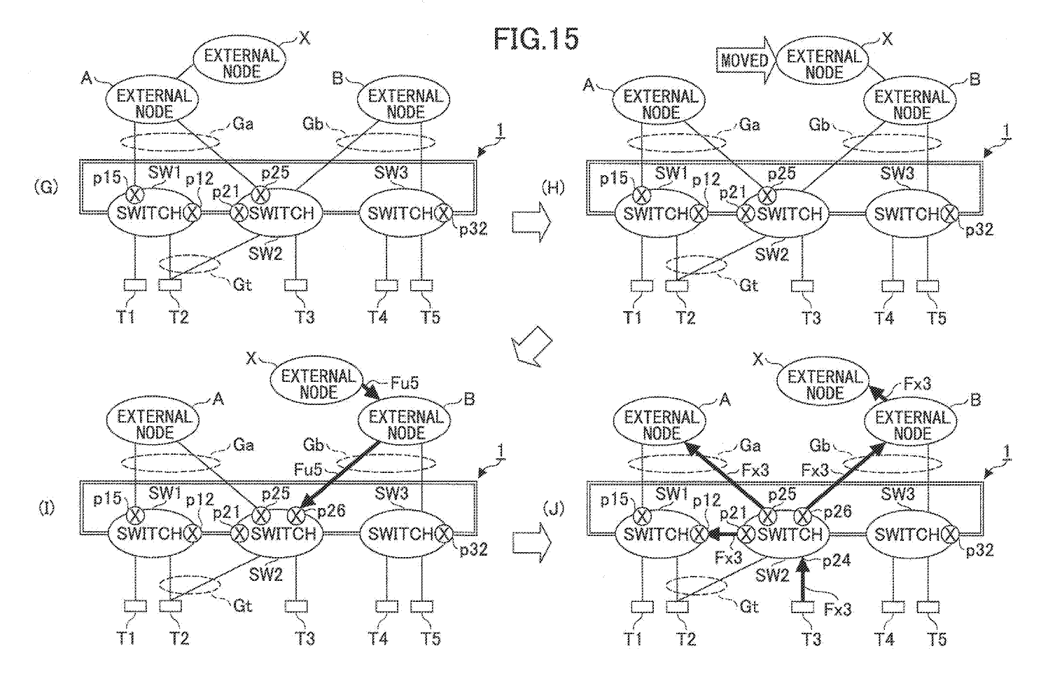

However, in Embodiment 2, there is a probability that the problem illustrated in FIG. 15 occurs. FIG. 15 illustrates the problem to be solved in Embodiment 2.

(G) of FIG. 15 illustrates the learning condition the same as (G) of FIG. 14. Under the leaning condition, the external node X moves on a side of the external node B as in (H) of FIG. 15. Such a movement of external nodes occurs when connections of cables are changed, changes of access points in wireless LAN, or the like.

(I) of FIG. 15 illustrates a learning condition in which a frame Fu5 of which transmission source is the external node X and of which destination is unknown is received by the receive port Pi corresponding to the port p26 of the switch SW2 after the external node X moves. In Embodiment 2, the new learnt content is added or merged. Therefore, the port p26 is registered in the relay DB 12 of the switch SW2 as a port corresponding to the external node X in addition to the ports p21 and p25.

(J) of FIG. 15 illustrates a relay path of a frame Fx3 from a terminal T3 to the external node X when the frame Fx3 is received by a receive port Pi corresponding to the port p24 of the switch 2 after ports corresponding to the moved external node X are learnt. If the group number corresponding to the frame Fx3 is determined to indicate a port group to which the transmit ports Po corresponding to at least the ports p21, p25 and p26 belong by the port group determining unit 13 corresponding to the port p24, the frame Fx4 is transmitted from the transmit port Po corresponding to the ports p21, p25 and p26 based on the learnt content recorded in the relay DB 12. The frame Fx4 transmitted from the port p26 is transferred to the external node X. Therefore, there is no problem in a relay of the frame Fx3 in the external node X. However, the frames Fx3 transmitted from the ports p21 and p25 become useless. Said differently, useless communication occurs.

### Embodiment 3

Embodiment 3 is described next as an example of solving the above problem. Embodiment 3 is described based on the features of Embodiment 2.

Features of Embodiment 3 which are not specifically described are substantially the same as those of Embodiment 2.

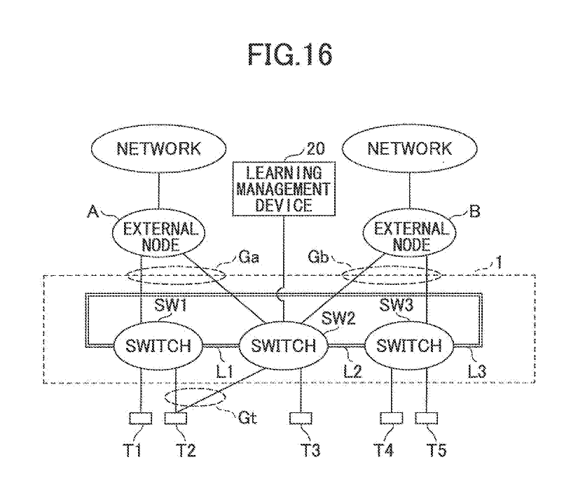

FIG. 16 illustrates a network structure of Embodiment 3. As illustrated in FIG. 16, a learning management device 20 is connected to a switch stack 1 via a line. The learning management device may be a dedicated device or a universal computer such as a personal computer (PC). Any of the switches SW included in the switch stack 1 may function as the learning management device 20. Referring to FIG. 16, the learning management device 20 is connected to the switch SW2 via the line. However, it is sufficient that the learning management device 20 is connected to any one of the switches SW1, SW2 and SW3. If the learning management device 20 is connected to the switch stack SW, it is possible to communicate to all the other switches SW via the stack link L1 to L3. Further, the connection between the learning management device 20 and the switch stack 1 may be universal or exclusive in terms of physical and logical structures.

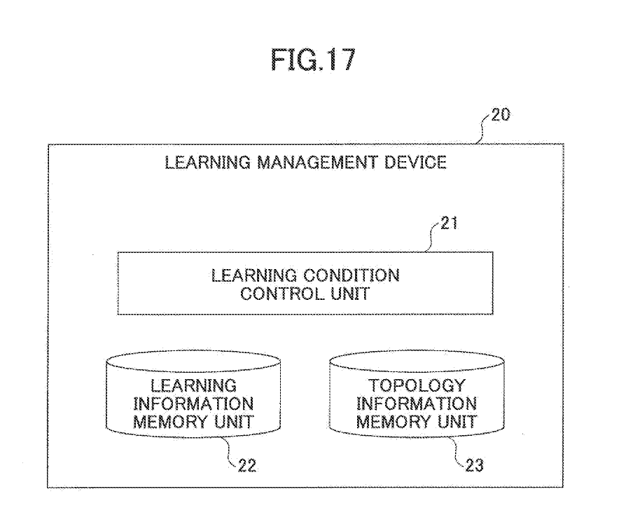

FIG. 17 illustrates a functional configuration of the learning management device. Referring to FIG. 17, the learning management device 20 includes a learning condition control unit 21, a learning information memory unit 22, and a topology information memory unit 23.

The learning condition control unit 21 controls learning conditions of the switches SW included in the switch stack 1 using the learning information memory unit 22 and the topology information memory unit 23. The learning condition is mainly controlled by instructing changes of the learning conditions to the switches SW. The learning information memory unit 22 stores information which includes the content of the relay DB 12 and indicates the learning conditions of the switches SW included in the switch stack 1. The learning management device 20 uniquely or totally collects or manages the learning conditions of the switches SW. The collection of the information indicative of the learning conditions of the switches is carried out upon reports from the switches SW. Specifically, the relay units 11 of the switches SW report changes of contents occurring in the relay DBs 12 of the switches 12 to the learning condition control unit 21 when any one of the contents of the relay DBs 12 changes. The learning condition control unit 21 updates the learning information memory unit 22 in response to the report.

The topology information memory unit 23 stores topology information of the switch stack 1. The topology information of the switch stack 1 is information indicative of a connecting condition of the switches included in the switch stack 1. Specifically, the topology information indicates ports for connecting the switches SW to the other switches SW. The topology information may be previously set by an administrator or the like and automatically determined by the learning condition control unit 21.

The learning information memory unit 22 is realized when a program recorded in a memory device of the learning management device 20 is carried out by a process in a CPU of the learning management device 20. The learning information memory unit 22 and the topology information memory unit 23 are realized by using a part of the memory device of the learning management device 20.

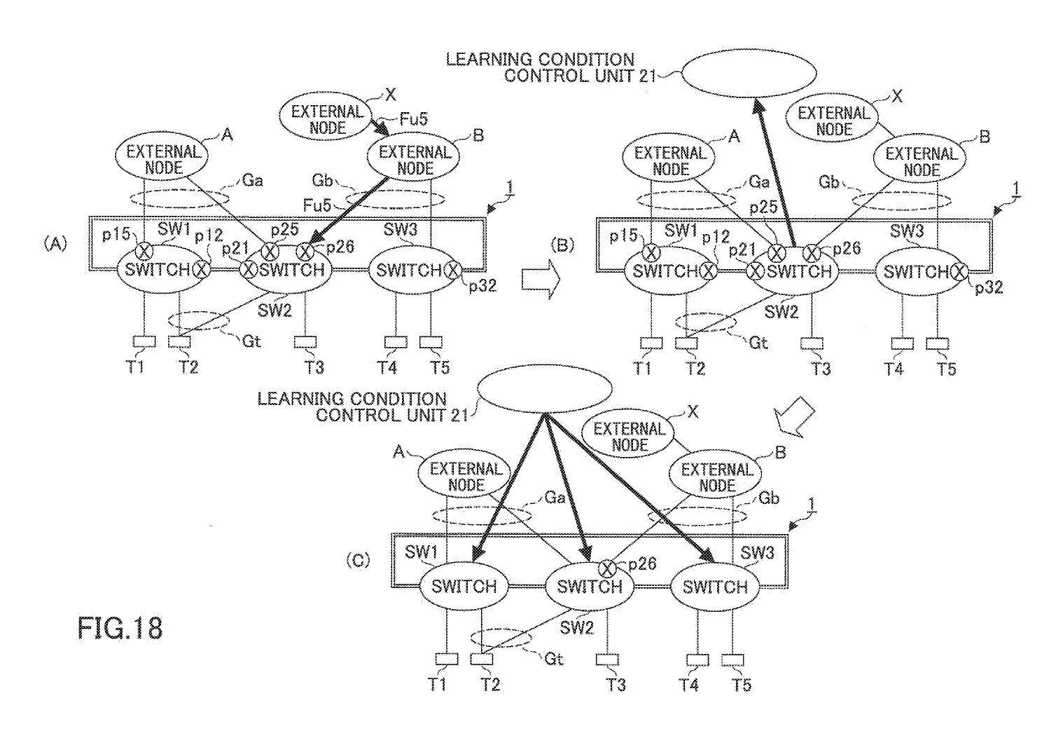

FIG. 18 illustrates an operation example of the switch stack of Embodiment 3.

(A) of FIG. 18 matches (I) of FIG. 15. Referring to (A) of FIG. 18, the switch SW2 newly learns the external node. The new learning means updating the relay DB 12. Therefore, the process illustrated in (B) of FIG. 18 is carried out as described above. The relay unit 11 of the switch SW2 reports the newly learnt content (correspondence information between the port p26 and the external node X) to the learning condition control unit 21 of the learning management device 20. The report may be carried out using a predetermined control frame.

The learning condition control unit 21 determines whether the newly learnt external node moves based on the report, the information stored in the learning information memory unit 22, and the topology information stored in the topology information memory unit 23. Referring to FIG. 18, it is detected that the external node X moves from a side of the link aggregation group Ga to the link aggregation group Gb.

When the learning condition control unit 21 detects that the newly learnt external node has moved, the learning condition control unit 21 transmits an instruction of deleting all learnt information corresponding to the external node X except for the port p26 which has newly learnt the correspondence information between the port p26 and the external node X. Referring to (C) of FIG. 18, the above instruction of deleting all learnt information is illustrated. The switches SW remove the learnt information, i.e. entries into the relay DBs, corresponding to the external node X in response to the instruction from the learning condition control unit 21. Therefore, the correspondence information between the external node X and the port p26 is left only in the relay DB of the switch SW2.

As a result, the problem in reference to FIG. 15 is solved. Thus, unnecessary communications caused by the additional learning upon movement of the external node X are prevented from generating. Even though the learnt information corresponding to the external node X is removed, new learning is carried out for the external node X. Therefore, the frame to the external node X is not prevented from being relayed.

Referring to FIG. 18, the additional learning is carried out. A report from the relay units 11 of the switches SW to the learning condition control unit 21 is not limited to a case where the additional learning is carried out. For example, learning of a new node is reported to the learning condition control unit 21. When any kind of updating occurs in the relay DB 12 in the switch SW, the relay unit 11 of the switch SW reports the updating to the learning condition control unit 21.

Referring to FIG. 18, the example that learnt information corresponding to the moved external node X is removed by the learning condition control unit 21 has been described. However, all learnt information corresponding to the moved external node X may not be removed. For example, only the learnt information corresponding to the port which may be relayed to the transmission-source can be removed. Referring to FIG. 18, the transmission-source is on a side of the link aggregation group Ga.

Next, processes carried out by the switches SW in Embodiments 1 to 3 are described.

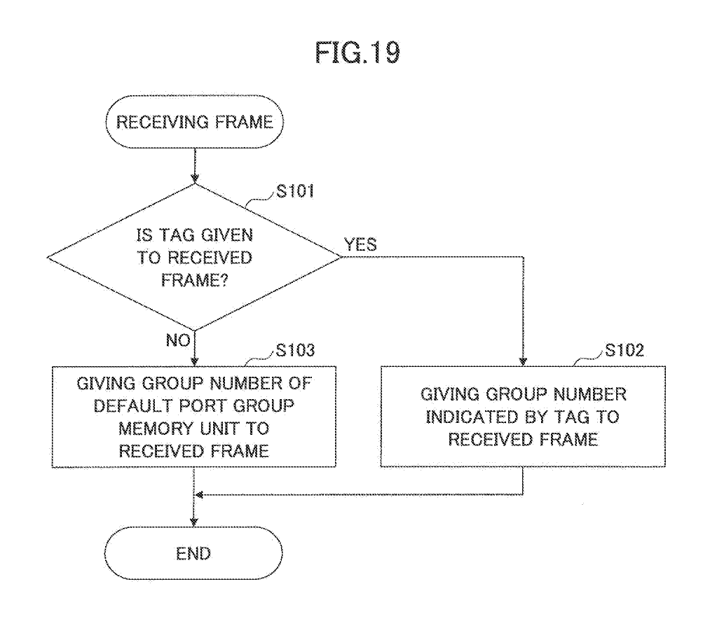

FIG. 19 is a flowchart illustrating processes in the frame receiving unit of Embodiments 1 to 3.

When the frame has received the receive port Pi, the port group determining unit 13 confirms whether a tag indicative of a group number is given to the received frame in step S101. When the tag is given in YES of step S101, the port group determining unit 13 determines the group number indicated by the tag as the group number corresponding to the received frame in step S102. When the tag is not given to the received frame in NO of step S101, the port group determining unit 13 determines the group number recorded in the default port group memory unit 14 as the group number corresponding to the received frame in step S103. The group number determined by the port group determining unit 13 is administrated in association of the received frame.

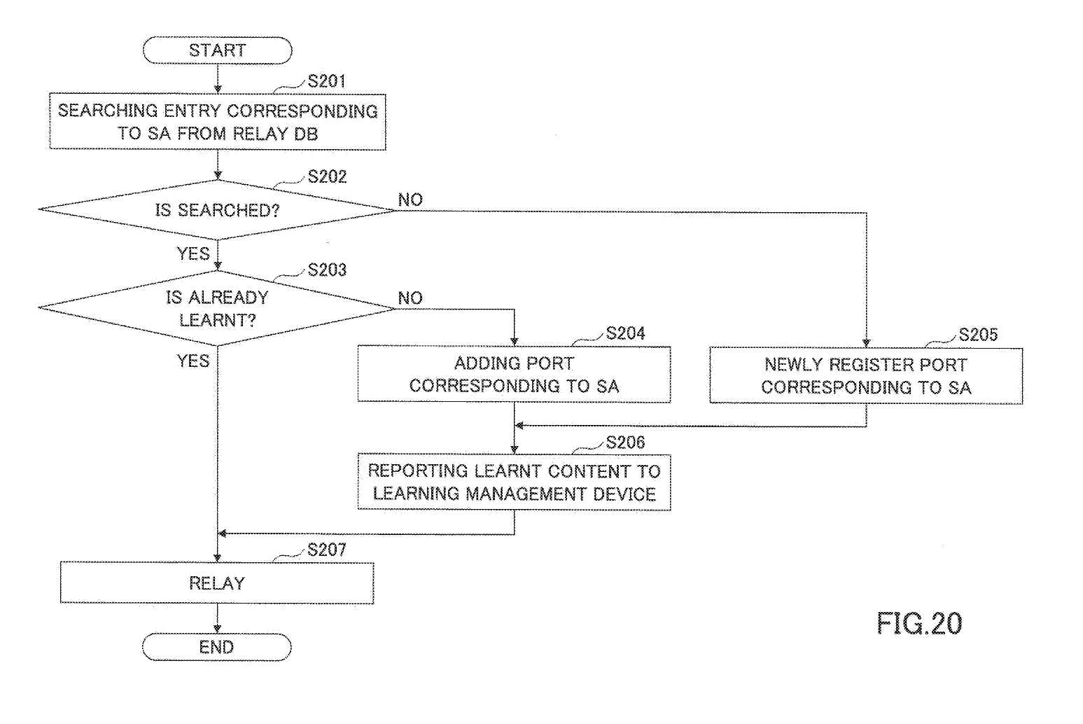

When the processes with the frame receiving unit I end, the received frame is carried out by the relay unit 11. FIG. 20 is a flowchart illustrating a procedure in the relay unit of Embodiments 1 to 3.

The relay unit 11 searches an entry corresponding to a transmission-source MAC address (SA) of the received frame from the relay DB 12 in step S201. When the entry is searched in YES of step S202, the relay unit 11 confirms whether the transmit port Po corresponding to the receive port Pi of the received frame is already registered in the entry in step S203. Said differently, it is determined whether the corresponding relationship between the transmission source MAC address of the received frame and the transmit port Po corresponding to the receive port Pi of the received frame has already been learnt.

If the corresponding relationship has already been learnt in Yes of step S203, the relay unit 22 does not update the relay DB 12, and the relay process is carried out in step S207.

When the corresponding relationship is not learnt yet in NO of step S203, the relay unit 11 adds the transmit port Po corresponding to the receive port Pi to the relay DB 12 in step S204 as a port corresponding to the transmission-source MAC address in step S204. When another transmit port is associated with the transmission-source MAC address, the association with the other port is not removed and a new association with a new transmission port Po is additionally registered into the relay DB 12. Steps S203 and S204 are not carried out in Embodiment 1.

When the corresponding entry is not searched in NO of step S202, the relay unit 11 registers the transmit port Po corresponding to the receive port Pi into the relay DB 12 as a port corresponding to the transmission-source MAC address in step S205.

The relay unit 11 transmits a currently learnt content to the learning condition control unit 21 of the learning management device 20 in step S206 after the steps S204 and S205. The currently learnt content is a transmission source MAC address and identification information of the transmit port Po corresponding to the transmission source MAC address. Step S206 is carried out in Embodiment 3. Subsequently, the relay unit 11 carries out a relay process in step S207.

The relay process includes searching the transmit port Po corresponding to the destination MAC address of the received frame from the relay DB 12 and inputting the received frame to the frame transmitting unit O to which the searched transmit port Po belongs. When the destination MAC address of the received frame is not registered in the relay DB, the received frame is subjected to flooding. The group number determined in the process illustrated in FIG. 19 is input into the frame transmitting unit O together with the received frame. When the number of the frame transmitting unit O to which the received frame is input is limited to one, said differently when the destination of the received frame is one learnt node, the relay unit 11 inputs the filtering unnecessity instruction to the frame transmitting unit O.

After the process with the relay unit 11 ends, a process of transmitting the received frame is carried out by the frame transmitting unit O to which the received frame is input from the relay unit 11.

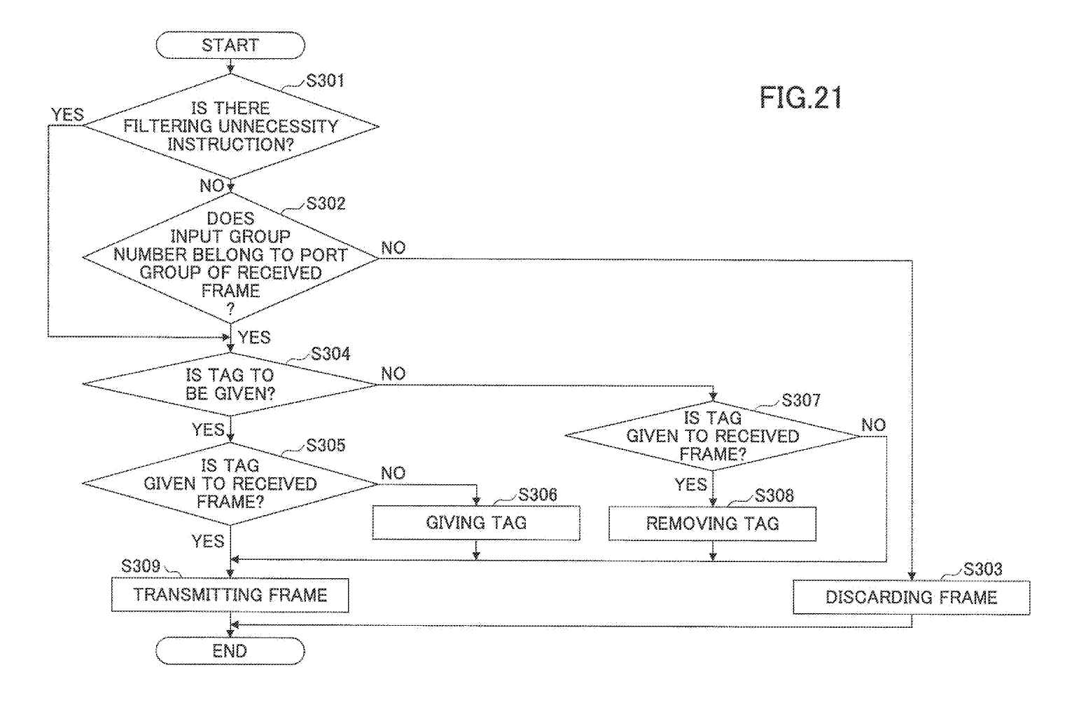

FIG. 21 is a flowchart illustrating the procedure in the frame transmitting unit O of Embodiments 1 to 3.

In response to the input of the received frame or the like, the filtering unit 15 confirms whether the filtering unnecessity instruction is input in step S301. When the filtering input instruction is not input in NO of step S301, the filtering unit 15 determines whether the input group number is recorded in the port group membership memory unit 16 in step S302. The input group number is a group number associated with the received frame. More specifically, it is determined whether a value of bit corresponding to the group number is “1” in the port group membership memory unit 16. It is determined whether the frame transmitting unit O belongs to a port group corresponding to the input group number. When the input group number is not recorded in the port group membership memory unit 16 in NO of step S302, the filtering unit 15 discards the received frame in step S303.

When the filtering unnecessity instruction is input in YES of step S301 or the input group number is recorded in the port group membership memory unit 16 in YES of step S302, the filtering unit 15 inputs the received frame to the tagging unit 17. In Embodiments 2 and 3, step S301 is not carried out and step S302 is carried out.

When the received frame is input, the tagging unit 17 uses the tagging necessity memory unit 18 to determine whether a tag is to be given to the received frame in step S304. When the tag is to be given, said differently when “1” is recorded in the tagging necessity memory unit in YES of step S304, the tagging unit 17 determines whether the tag is given to the received frame in step S305. Thus, the received frame to which the tag is given by the tagging unit of the other switch SW of the switch stack 1 reaches the tagging unit 17 of the switch SW with the tag being given to the received frame. However, the tag given to the received frame may be removed by the frame receiving unit I. In this case, step S305 is not carried out and step S306 is carried out. Further, steps S307 and S308 are not carried out.

When the tag is not given in NO of step S305, the tagging unit 17 gives a tag indicative of the group number input in the frame transmitting unit O to the frame in step S306.

When the tag is not to be given, said differently when “0” is recorded in the tagging necessity memory unit in NO of step S304, the tagging unit 17 determines whether the tag is given to the received frame in step S307. When the tag is given to the received frame in YES of step S307, the tagging unit 17 removes the tag from the received frame in steps S308.

In YES of step S305, NO of step S307, step S306, and step S308, the transmit port Po transmits the received frame in step S309.

In Embodiments 1, 2 and 3, the port group determining unit 13 and the default port group memory unit 14 are provided for each receive port Pi. Further, the filtering unit 15, the port group membership memory unit 16, the tagging unit 17 and the tagging necessity memory unit 18 are provided for each transmit port Po. However, the number of these portions may be one in common to each receive port Pi or each transmit port Po. When the number of these portions is one, there is a probability that performance drops faster. This is because a parallel processing with the receive ports Pi or the transmit ports Po is not carried out, and loads on these portions increase. Therefore, it is preferable to provide these portions for the receive port Pi and the transmit ports Po.

Thus, Embodiments 1 to 3 make it possible to restrict a broadcast storm caused by a redundant relay path and simultaneously provide a link aggregation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay device comprising:
a port group determining unit configured to associate, when a frame is received by a receive port, group identification information which indicates any one of a plurality of combinations of ports set up in the receive port, with the frame;
a relay unit configured to learn a correspondence between the receive port and a node which is a transmission source of the frame to the receive port and determine a transmit port from which the frame is transmitted based on a learning condition including the learnt correspondence;
a port group membership memory unit configured to store a membership information piece indicative of the plurality of combinations of ports;
a filtering unit configured to limit the transmit port from which the frame is transmitted; and
a tagging unit configured to give the group identification information to the frame to be transmitted,
wherein the port group determining unit associates the group identification information to the received frame when group identification information has been given to the received frame, and
the filtering unit does not limit the transmit port from which the frame is transmitted when the learnt correspondence includes the receive port corresponding to the transmit port and the node which is the transmission source corresponding to a destination of the received frame.

2. The relay device according to claim 1, further comprising:
a tagging necessity memory unit configured to store information indicative of necessity of giving the group identification information to the frame for each of the transmit ports,
wherein the tagging unit gives the group identification information to the frame to be transmitted based on the information stored in the tagging necessity memory unit.

3. The relay device according to claim 2,
wherein when the group identification information is given to the received frame, the group identification information is deleted from the frame based on the information stored in the tagging necessity memory unit.

4. The relay device according to claim 1,
wherein the port group membership memory unit stores the membership information piece indicative of the plurality of combinations of ports including the transmit port for each of the ports.

5. A relay device comprising:
a port group determining unit configured to associate, when a frame is received by the receive port, group identification information which indicates any one of a plurality of combinations of ports set up in the receive port, with the frame;
a relay unit configured to learn a correspondence between the receive port and a node which is a transmission source of the frame to the receive port and determine a transmit port from which the frame is transmitted based on a learning condition including the learnt correspondence;
a port group membership memory unit configured to store a membership information piece indicative of the plurality of combinations of ports;
a filtering unit configured to limit the transmit port from which the frame is transmitted; and
a tagging unit configured to give the group identification information to the frame to be transmitted,
wherein the port group determining unit associates the group identification information to the received frame when group identification information has been given to the received frame, and
when another frame is received via another receive port and a transmission source of the other frame is the node in the learnt correspondence, the relay unit additionally associates the other receive port with the node in the learnt correspondence.

6. The relay device according to claim 5, further comprising:
a learning management device configured to store other learning conditions of one or more other relay devices which are connected to the relay device to form redundant relay paths at predetermined times in response to a change of the learning conditions and to store a state of the connection with the one or more other relay devices,
wherein the relay unit reports the change of the learning condition to the learning management device and changes the learning condition upon receipt of an instruction from the learning management device.

7. The relay device according to claim 5, further comprising:
a tagging necessity memory unit configured to store information indicative necessity of giving the group identification information to the frame for each of the transmit ports,
wherein the tagging unit gives the group identification information to the frame to be transmitted based on the information stored in the tagging necessity memory unit.

8. The relay device according to claim 7,
wherein when the group identification information is given to the received frame, the group identification information is deleted from the frame based on the information stored in the tagging necessity memory unit.

9. The relay device according to claim 5,
wherein the port group membership memory unit stores the membership information piece indicative of the plurality of combinations of ports including the transmit port for each of the ports.

10. A relay method used in a relay device including receive ports for receiving frames and transmission ports for transmitting the frames comprising:
determining a port group to associate, when the frame is received by the receive port, group identification information which indicates any one of a plurality of combinations of ports set up in the receive port, with the frame;
learning a correspondence between the receive port and a node which is a transmission source of the frame to the receive port and determining the transmit port from which the frame is transmitted based on a learning condition including the learnt correspondence;
storing a membership information piece indicative of the plurality of combinations of the ports;
limiting the transmit port from which the frame is transmitted; and
giving the group identification information to the frame to be transmitted,
wherein the determining associates the group identification information to the received frame when group identification information has been given to the received frame, and
the limiting does not limit the transmit port from which the frame is transmitted when the learnt correspondence includes the receive port corresponding to the transmit port and the node which is the transmission source corresponding to a destination of the received frame.

11. A relay method used in a relay device including receive ports for receiving frames and transmission ports for transmitting the frames comprising:
determining a port group to associate, when the frame is received by the receive port, group identification information which indicates any one of a plurality of combinations of ports set up in the receive port, with the frame;
learning a correspondence between the receive port and a node which is a transmission source of the frame to the receive port and determining the transmit port from which the frame is transmitted based on a learning condition including the learnt correspondence;
storing a membership information piece indicative of the plurality of combinations of the ports;
limiting the transmit port from which the frame is transmitted; and
giving the group identification information to the frame to be transmitted,
wherein the determining associates the group identification information to the received frame when group identification information has been given to the received frame, and
when the frame is received via the receive port and a transmission source of the other frame is the node in the learnt correspondence, the learning additionally associates the other receive port with the node in the learnt correspondence.
